(19) United States
(12) Patent Application Publication
(10) Pub. No.: US 2026/0118322 A1
(43) Pub. Date: Apr. 30, 2026

(54) SECOND HARMONIC GENERATION FOR ESTIMATING THE STATE OF CHARGE OF LITHIUM-ION BATTERIES

(71) Applicant: UT-Battelle, LLC, Oak Ridge, TN (US)

(72) Inventors: Pradeep Ramuhalli, Knoxville, TN (US); Hongbin Sun, Oak Ridge, TN (US); Ruhul Amin, Knoxville, TN (US); Ilias Belharouak, Knoxville, TN (US)

(21) Appl. No.: 19/314,155

(22) Filed: Aug. 29, 2025

Related U.S. Application Data
(60) Provisional application No. 63/711,170, filed on Oct. 24, 2024.

(51) Int. Cl. G01N 29/44; G01N 29/04; H01M 10/42

(52) U.S. Cl. CPC G01N 29/4472; G01N 29/04; H01M 10/4285; G01N 2291/023; G01N 2291/048; G01N 2291/102

(57) ABSTRACT

An improved system for estimating the SoC of a battery is provided. In one embodiment, an ultrasonic pulser transmits a multiple-cycle sine wave at an excitation frequency through the thickness of a lithium-ion battery. Due to the inherent acoustic nonlinearity of composite materials within the lithium-ion battery (electrodes and electrolytes), part of the ultrasonic energy is converted into a second harmonic wave. An ultrasonic receiver detects this wave on the opposite side of the battery. The strength of the second harmonic is quantified by a nonlinear parameter β′, which correlates linearly with the battery's SoC, increasing with charging and decreasing with discharging. By establishing a linear relationship between β′ and SoC through non-destructive calibration, the system can then estimate the SoC of any battery by measuring the nonlinear parameter β′. This technique enables real-time, accurate, online and offline SoC estimation, making it highly suitable for vehicular applications and non-vehicular applications alike.

### CROSS-REFERENCE TO RELATED APPLICATIONS

This application claims the benefit of U.S. Provisional Application 63/711,170, filed Oct. 24, 2024, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to systems for performing state of charge estimations for lithium-ion batteries.

### BACKGROUND OF THE INVENTION

One of the most important features of a battery management system (BMS) is the ability to estimate a battery's state of charge (SoC). A battery's SoC is the existing energy level of the battery, expressed as a percentage of its total capacity. Knowledge of the SoC helps prevent overcharging or over-discharging, both of which can damage the battery or create safety hazards. In addition, accurate SoC measurements help the BMS extend the battery's lifespan and predict battery servicing or replacement, particularly for electric vehicles.

Conventional SoC estimation methods include the discharge test method, the Ampere-Hour integral method, the open-circuit voltage method, and the battery model-based method. These methods require either a significant time to execute, or they require the measurement of extrinsic parameters, e.g., voltage, current, temperature, running time, and advanced algorithms. Such conventional methods require expensive hardware and complex software. In general, it is challenging to estimate the SoC of commercial batteries without discontinuing the power supply or deconstructing the battery. These methods generally cannot be applied when the battery is offline or disconnected, which restricts their usefulness for diagnostics, second-life applications, or field inspections. Other conventional methods for SoC estimation use ultrasonic signal amplitude, velocity, or attenuation. However, these parameters show a complex relationship with the battery SoC.

Accordingly, there remains a continued need for an improved system for estimating a battery's SoC. In particular, there remains a continued need for a low-cost and reliable system for online/offline SoC estimation of batteries, including lithium-ion batteries by example.

### SUMMARY OF THE INVENTION

An improved system for estimating the SoC of a battery is provided. The system uses an innovative nonlinear ultrasonic methodology based on second harmonic generation. In one embodiment, an ultrasonic pulser transmits a multiple-cycle sine wave at an excitation frequency through the thickness of a lithium-ion battery. Due to the inherent acoustic nonlinearity of composite materials within the lithium-ion battery (electrodes and electrolytes), part of the ultrasonic energy is converted into a second harmonic wave. An ultrasonic receiver detects this wave on the same/opposite side of the battery. The strength of the second harmonic is quantified by a nonlinear parameter β′, which correlates linearly with the battery's SoC, increasing with charging and decreasing with discharging. By establishing a linear relationship between β′ and SoC through non-destructive calibration, the system can then estimate the SoC of any battery by measuring the nonlinear parameter β′. This technique enables real-time, accurate SoC estimation without the need for electrical probing, making it highly suitable for embedded diagnostics in vehicular applications and non-vehicular applications alike. Other applications include public utilities and the assessment of battery health for second life uses.

The improved system represents a marked departure from conventional SoC methods, which rely on the measurement of external parameters such as voltage, current, temperature, and operating time. In contrast, the improved system does not require long-term charge/discharge tests to acquire historical current or voltage data. Conventional methods also necessitate that the battery is connected to an active circuit, whereas the improved system can determine battery SoC regardless of whether the battery is online or offline, and in real time. Additionally, conventional methods depend upon parameters with complex and non-linear relationships to SoC, making conventional methods difficult to implement and prone to inaccuracies. The improved system instead uses a dimensionless parameter β′ exhibiting a relatively linear correlation with SoC, which facilitates simpler implementation, improved accuracy, and lower operating costs.

These and other features and advantages of the present invention will become apparent from the following description of the invention, when viewed in accordance with the accompanying drawings and appended claims.

### BRIEF DESCRIPTION OF THE DRAWINGS

FIG. 1 illustrates a system for estimating the state of charge of a battery in accordance with an embodiment of the invention.

FIG. 2 illustrates a graph correlating battery state of charge with a nonlinear parameter related to second harmonic generation within a battery.

FIG. 3 illustrates a flow chart for a method of estimating the state of charge of a battery in accordance with an embodiment of the invention.

FIG. 4 is a graph illustrating a time-domain signal collected with an excitation amplitude of 160V.

FIG. 5 is a graph illustrating a frequency-domain signal converted from the time-domain signal plot of FIG. 4.

FIG. 6 is a graph illustrating data points of

$$( {A}_{1}^{2} , {A}_{2} )$$

for five excitation amplitudes, depicting a linear relationship with SoC.

FIG. 7 is a graph illustrating the nonlinear parameter β′ as measured over four charge/discharge cycles in accordance with a laboratory example.

### DETAILED DESCRIPTION OF THE CURRENT EMBODIMENT

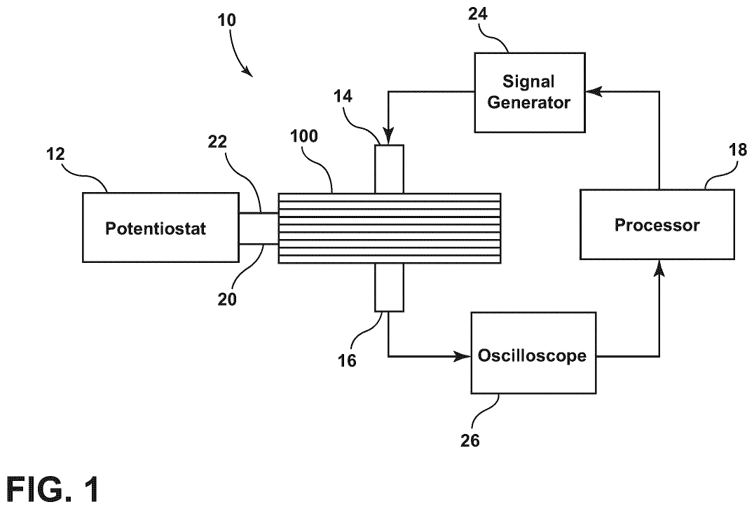

Referring to FIG. 1, a system for estimating the state of charge (SoC) of a battery 100 is illustrated and generally designated 10. As more specifically set forth below, the system 10 transmits ultrasonic energy at a first harmonic frequency through the thickness of the battery 100, and part of the ultrasonic energy is converted into a second harmonic wave. The strength of the second harmonic wave is quantified by a nonlinear parameter β′, which correlates linearly with SoC, increasing with charging and decreasing with discharging.

With reference to the embodiment shown in FIG. 1, the system includes a potentiostat 12, an ultrasonic transmitter 14, an ultrasonic receiver 16, and a processor 18. Beginning first with the potentiostat 12, this component comprises an electronic device that is configured to control and measure the voltage and current in the battery 100. The potentiostat 12 maintains a controlled voltage between a working electrode 20 and a reference electrode 22, while measuring the current that flows as a result of electrochemical reactions. The potentiostat 12 discharges the battery 100 by acting as a load, pulling a specific current until the battery voltage drops to a preset minimum threshold. The potentiostat then reverses roles and provides current to the battery, acting as a power source, optionally as a constant current source until the battery reaches an upper voltage limit and thereafter a constant voltage source to allow the current to taper off naturally at approximately 100% SoC.

The system 10 also includes the above-noted ultrasonic transmitter 14 and ultrasonic receiver 16, each being positioned on opposite sides of the battery 100. The ultrasonic transmitter 14 includes a transducer that converts electrical signals into sub-acoustic sound waves, optionally above 20 kHz, for propagation through the battery 100. The ultrasonic receiver 16 detects and converts the received ultrasonic waves into an electrical signal for output to the processor 18. In some embodiments, the ultrasonic receiver 16 includes a piezoelectric element that vibrates in response to ultrasonic frequencies, generating a small voltage that is proportional to the ultrasonic wave. In one embodiment, the excitation frequency includes a frequency of 2.5 MHz, and the second harmonic includes a frequency of 5.0 MHz. Still other frequency components can be used in other embodiments as desired.

More specifically, the ultrasonic transmitter 14 is configured to cause a repeating sine wave to interact with the battery 100, the repeating sine wave having an excitation frequency f₀. The ultrasonic transmitter 14 (when coupled to a suitable signal generator 24) is configured to generate the repeating sine wave for each of a predetermined number N_{M} of states of charge SoCᵢ per cycle, where 1≤i≤N_{M}. The ultrasonic receiver 16 generates output signals uᵢ_{ⱼ}(t) corresponding to the interactions between the ultrasonic waves and the battery 100, the output signals being digitized by an oscilloscope 26 before being provided to the processor 18. The output signals include a first harmonic and a second harmonic, the frequency of the second harmonic being twice that of the first harmonic.

The processor 18 may be implemented as one or more general-purpose microprocessors, digital signal processors (DSPs), application-specific integrated circuits (ASICs), microcontrollers, or any other form of logic circuitry that is capable of executing machine-readable instructions stored in non-transitory machine-readable memory. The processor 18 is configured to produce a spectra uᵢ_{ⱼ}(f) corresponding to the output signals uᵢ_{ⱼ}(t) as received from the oscilloscope 26. The processor 18 is also configured to obtain (for each of the N_{M} states of charge SoCᵢ per cycle) a respective nonlinear parameter

$${β}_{i}^{′}$$

by dividing the second harmonic's amplitude by the square of the first harmonic's amplitude. In particular, the nonlinear parameter β′ is calculated according to equation (1) below:

$${β}^{′} = {A}_{2}^{′} / {A}_{1}^{′2} \qquad ( 1 )$$

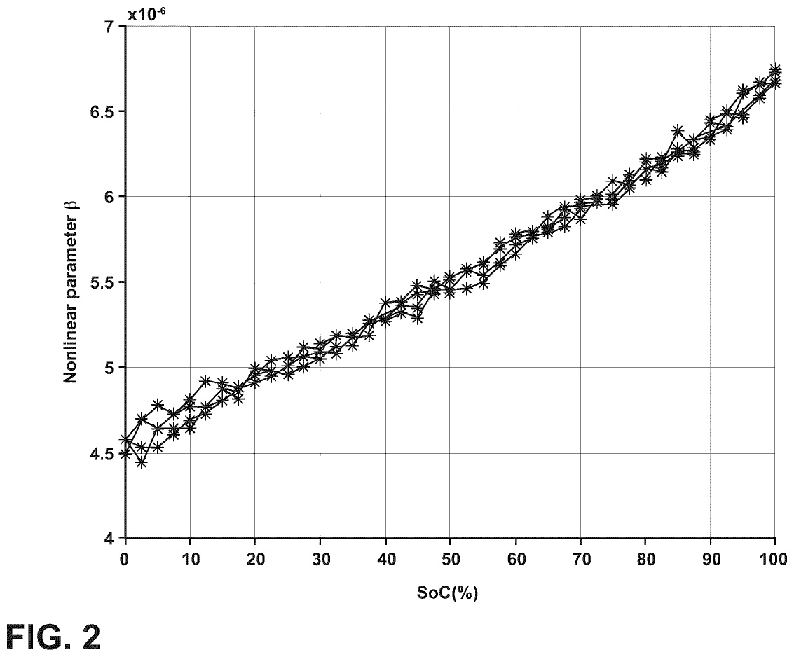

The linear relationship between β′ and SoC is illustrated in FIG. 2. During charging, lithium ions are driven from the cathode to the anode. This migration causes structural changes in the electrodes, including expansion of the anode and contraction of the cathode. These mechanical changes can introduce nonlinearities in the acoustic response of the battery. Meanwhile, the cathode materials often undergo phase transformations, and these phase transformations can increase the acoustic nonlinearity. The measured nonlinear parameter β′ functions as a clear indicator of these changes in acoustic nonlinearity throughout the charging and discharging process.

To improve the fidelity of this linear correlation, the processor 18 collects data from multiple charging and discharging cycles, ensuring a more accurate and robust representation of the relationship between β′ and SoC. In the embodiment of FIG. 2 for example, data from a four-cycle test was used to calculate the relationship between β′ and SoC. The processor 18 then calculates a correlation of the nonlinear parameter

$${β}_{i}^{′}$$

to the corresponding state of charge of the battery 100, storing the nonlinear parameter

$${β}_{i}^{′}$$

in computer readable memory as a function of the SoC of the battery.

The processor 18 can calculate a best-fit curve that models the relationship between the nonlinear parameter β′ and the battery's SoC, via any regression or curve fitting techniques (e.g., linear regression, second-order polynomial regression, or machine learning methods), providing an optimized straight-line approximation of this correlation. In the example of FIG. 2, the linear relationship is shown in equation (2) below:

$$β = 2.5 \cdot {10}^{- 6} \cdot SoC + 4.5 \cdot {10}^{- 6} \qquad ( 2 )$$

By solving for SoC, the linear relationship can be modeled according to equation (3) below:

$$S o C = \frac{( β - 4.5 \cdot {10}^{- 6} )}{2.5 \cdot {10}^{- 6}} \qquad ( 3 )$$

Once the foregoing calibration is complete, the processor 18 causes the ultrasonic transmitter 14 to generate a repeating sine wave (via the signal generator 24) and causes the ultrasonic receiver 16 to issue output signals uⱼ(t) (via the oscilloscope 26). The processor 18 receives these output signals uⱼ(t) and produces a spectra uⱼ(f) corresponding to the output signals uⱼ(t). The processor 18 then obtains a nonlinear parameter β′ by combining the first harmonic amplitude

$${A}_{{( {f}_{0} )}_{j}}^{′}$$

with the second harmonic amplitude

$${A}_{{( 2 {f}_{0} )}_{j}}^{′}$$

of the corresponding spectra. Lastly, the processor 18 determines the SoC in the battery 100 based on the nonlinear parameter β′ and the stored correlation (e.g., equation (3) above).

In certain embodiments, a calibration battery is used as an earlier instance of a test (operational) battery to develop the linear correlation between SoC and β′. Although the calibration battery and the test battery are physically distinct units, they are of the same type, meaning they share the same electrochemical composition, cell architecture, and manufacturer specifications. The calibration battery is cycled (one or more times) and characterized prior to the test battery and is used to generate the linear correlation between SoC and β′. Because the calibration battery and the test battery are of the same type, the linear model derived from the calibration battery is sufficiently representative of the test battery's behavior.

In some embodiments, the processor 18 is configured to compare the calculated SoC to a predefined threshold value or a set of threshold values. These thresholds may correspond to safety limits, performance constraints, or an application-specific operating window. If the determined SoC falls below or exceeds the threshold value(s) (indicating a potentially unsafe, suboptimal, or undesired operating condition), the processor is configured to initiate a corrective action. Such corrective actions can include: modifying the charge or discharge current; placing the battery in a reduced power mode; issuing an alert or notification; and/or disconnecting the battery 100 from a load or charging source. Still other corrective actions can be implemented in other embodiments.

The present embodiments are well suited for determining the SoC of lithium-ion batteries, by non-limiting example. Lithium-ion batteries are known to possess high energy density, a low self-discharge rate, long cycle life, and compatibility with a wide range of consumer and automotive applications. Optional lithium-ion chemistries include lithium cobalt oxide (LiCoO₂), lithium iron phosphate (LiFePO₄), lithium nickel manganese cobalt oxide (LiNiMnCoO₂ or NMC). The battery 100 is optionally a vehicle battery, optionally being used in connection with battery electric vehicles and hybrid electric vehicles. Alternatively, the battery 100 forms part of a consumer electronics device, including for example mobile communication devices, tablet computers, wearable electronics, and smart appliances.

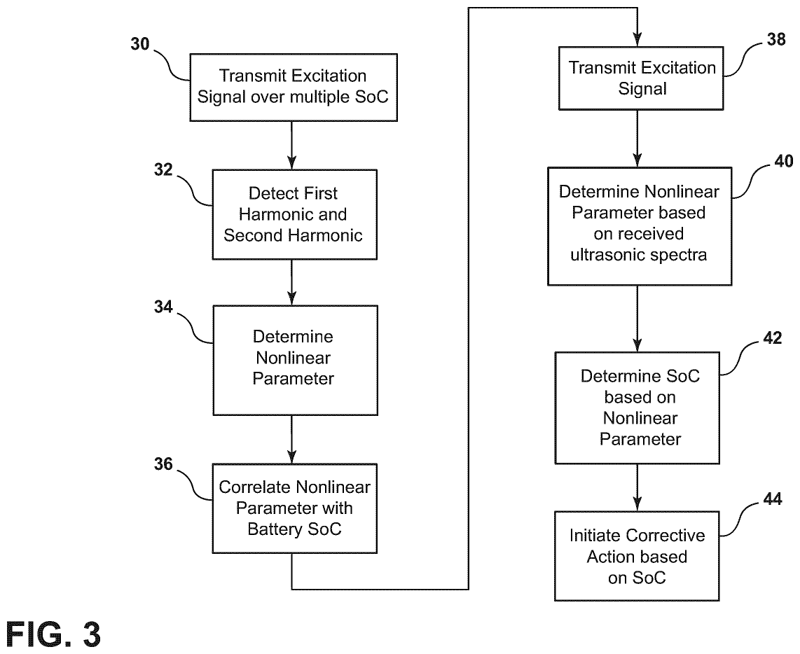

The present invention also provides a method for the real-time estimation of battery SoC. With reference to FIG. 3, the method includes propagating an ultrasonic excitation signal through a calibration battery at step 30 while incrementing through of a plurality of SoC levels (e.g., 0%, 10%, 20%, . . . , 100%), the ultrasonic excitation signal having an excitation frequency f₀ (e.g., 2.5 MHz). At step 32, the method then includes detecting, using an ultrasonic receiver, the amplitude of a first harmonic (e.g., 2.5 MHz) and the amplitude of a second harmonic (e.g., 5 MHz) at the opposing surface of the calibration battery for each SoC. At step 34, the method includes dividing the amplitude of the second harmonic by the square of the amplitude of the first harmonic, resulting in a parameter β′ that correlates linearly with battery SoC. This step is performed for each of incremented SoC, thus building a dataset that can be used to derive a best-fit curve for this linear correlation. For increased fidelity, the foregoing steps 30, 32, 34 are repeated for multiple battery charging and/or discharging cycles.

At step 36, the method includes correlating the nonlinear parameter β′ with the battery SoC, optionally using regression techniques to calculate a best-fit curve. The correlation is stored to computer readable memory for subsequent use with a test (operational) battery. Beginning at step 38, the foregoing steps are repeated for the test battery. With knowledge of the nonlinear parameter β′, and at step 40, the processor 18 can determine the nonlinear parameter β′ based on the received ultrasonic spectra uⱼ(f). At step 42, the processor 18 then determines the SoC in the battery 100 based on the nonlinear parameter β′ and the stored correlation. Optional additional steps include comparing the SoC to a predefined threshold value or a set of threshold values. These thresholds may correspond to safety limits, performance constraints, or an application-specific operating window. If the SoC falls below or exceeds the threshold value(s), the processor is configured to initiate a corrective action at step 44. Such corrective actions can include: modifying the charge or discharge current; placing the battery in a reduced power mode; issuing an alert or notification; and/or disconnecting the battery 100 from a load or charging source.

The present invention is further illustrated with reference to the following laboratory example, which is intended to be non-limiting.

Lithium-ion batteries (NMC622) were evaluated, having a total thickness of 4.4 mm. Two longitudinal transducers (Olympus C106 at 2.5 MHz, Olympus C110 at 5.0 MHz) provided an eight-cycle sinusoidal burst to the battery. The resulting ultrasonic wave propagated through the thickness of the battery and was captured by an ultrasonic receiver. The received signal was digitized by an oscilloscope (Tektronix MS044) and stored for further analysis. Multiple ultrasonic signals were collected under five different excitation amplitudes from 160V to 480V in 80V increments. The battery was charged and discharged using a potentiostat (Biologic SP-200), maintaining a constant current of 240 mA. Throughout the charge/discharge cycle, the nonlinear parameter was assessed at 15-minute intervals.

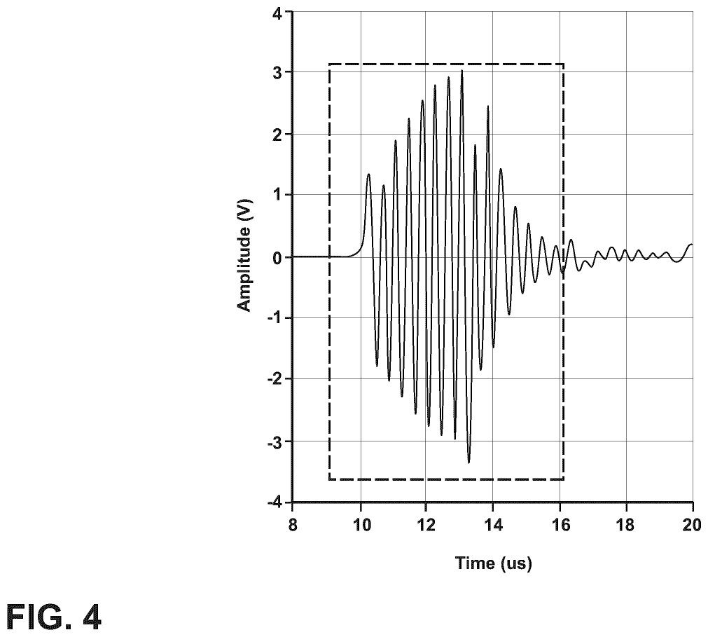

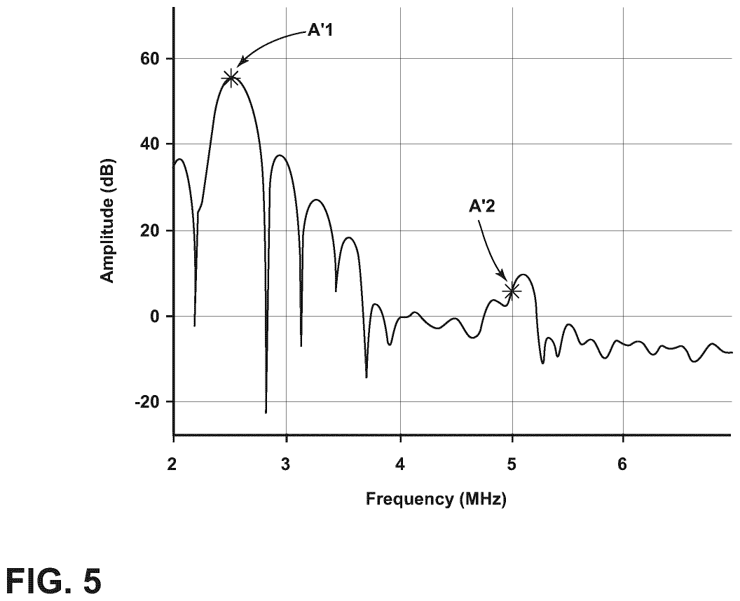

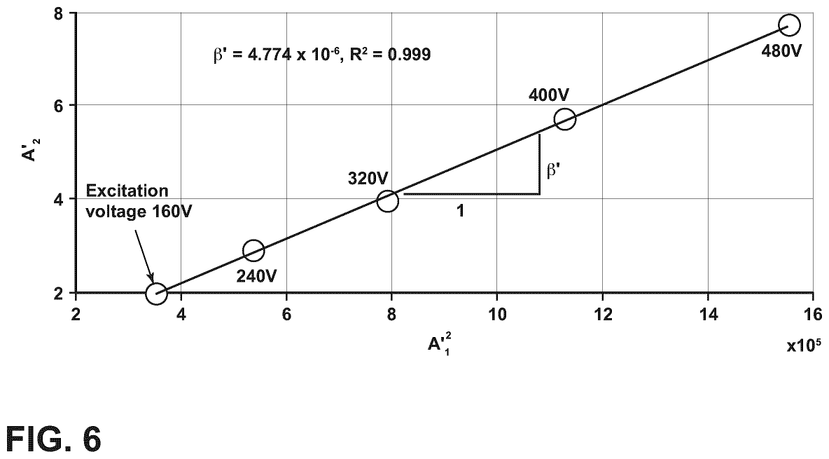

A time-domain signal collected with an excitation amplitude of 160V is shown in FIG. 4. The time-domain signal was windowed from 9 us to 16 us and then transferred to the frequency domain (shown in FIG. 5) using a fast Fourier transform. In this frequency spectrum, the amplitude A₁ at 2.5 MHz and the amplitude A₂ at 5.0 MHz were extracted. In FIG. 6, the data points of

$$( {A}_{1}^{2} , {A}_{2} )$$

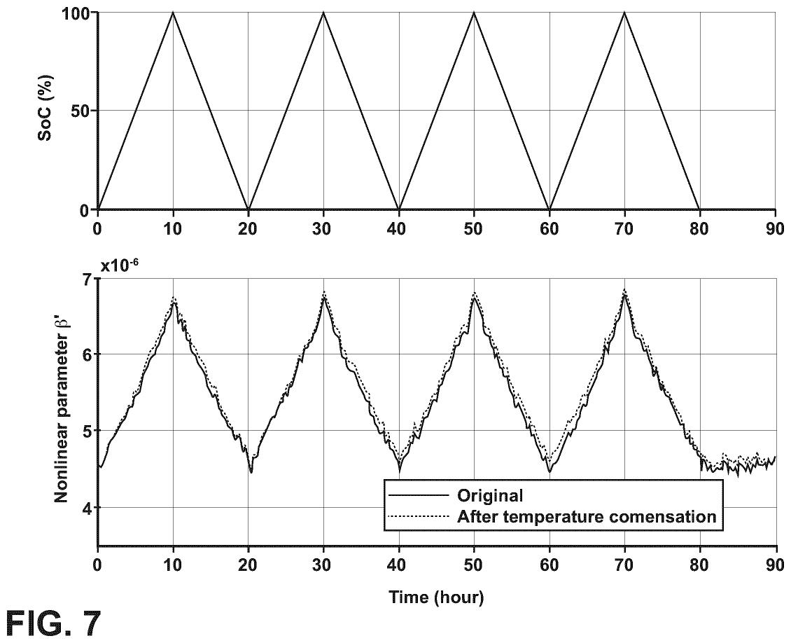

for five different excitation amplitudes were fitted using a linear relationship. The slope of the fitted curve represents the nonlinear parameter β′. The nonlinear parameter β′ was measured every fifteen minutes over four charge/discharge cycles, plotted in FIG. 7. During the charging process, the nonlinear parameter β′ progressively increased, escalating as the SoC advanced from 0% to 100%. Conversely, in the discharge phase, the nonlinear parameter β′ decreased with the SoC's return to 0%. The nonlinear parameter β′ was also sensitive to temperature change. The temperature sensitivity coefficient was estimated to be about 0.25×10⁻⁶/° C. The corrected nonlinear parameter with a temperature compensation is also plotted in FIG. 7.

To reiterate, the present invention includes a nonlinear ultrasonic method to estimate the SoC of lithium-ion batteries. The nonlinear parameter β′ was measured throughout multiple charge and discharge cycles. A robust linear relationship was observed between the nonlinear parameter β′ and actual SoC. The improved method represents a marked departure from conventional SoC methods, which rely on the measurement of external parameters such as voltage, current, temperature, and operating time. In contrast, the improved method does not require historical current or voltage data. Conventional methods also necessitate that the battery is connected to an active circuit, whereas the improved system can determine battery SoC with the stored correlation regardless of whether the battery is online or offline, and in real time. Additionally, conventional methods depend upon parameters with complex and non-linear relationships to SoC, making conventional methods difficult to implement and prone to inaccuracies. The improved method instead uses a dimensionless parameter β exhibiting a relatively linear correlation with SoC, which facilitates simpler implementation, improved accuracy, and lower operating costs.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. A system for determining a state of charge in a battery containing a lithium-based electrolyte, the system comprising:
a potentiostat for performing at least one cycle of charging a calibration battery to a maximum state of charge and discharging a calibration battery to a minimum state of charge;
an ultrasonic transmitter configured to, for each of a plurality of states of charge, cause an ultrasonic wave to propagate through the calibration battery;
an ultrasonic receiver configured to, for each of the plurality of states of charge, issue an output signal corresponding to an amplitude of a first harmonic of the ultrasonic wave and an amplitude of a second harmonic of the ultrasonic wave, the calibration battery being disposed between the ultrasonic transmitter and the ultrasonic receiver; and
a processor coupled, directly or indirectly, to each of the ultrasonic transmitter and the ultrasonic receiver, the processor being configured to:
for each of the plurality of states of charge, calculate a nonlinear parameter based on the amplitude of the first harmonic and the amplitude of the second harmonic;
calculate a correlation between the nonlinear parameter and the state of charge of the calibration battery and store the correlation in memory;
instruct the ultrasonic transmitter and the ultrasonic receiver to cause a further ultrasonic wave to propagate through a test battery and generate a further output signal corresponding to an amplitude of a first harmonic of the further ultrasonic wave and an amplitude of a second harmonic of the further ultrasonic wave;
calculate a nonlinear parameter of the test battery based on the amplitude of the first harmonic of the further ultrasonic wave and the amplitude of the second harmonic of the further ultrasonic wave;
determine a state of charge of the test battery based on the nonlinear parameter of the test battery and the stored correlation.

2. The system of claim 1, wherein the calibration battery is an earlier instance of the test battery.

3. The system of claim 1, wherein the calibration battery and the test battery are of the same type.

4. The system of claim 1, wherein:
the ultrasonic wave includes an excitation frequency which corresponds to the first harmonic of the ultrasonic wave; and
the second harmonic of the ultrasonic wave includes a frequency that is an integer multiple of the excitation frequency.

5. The system of claim 1, wherein the processor is configured to calculate the correlation via linear, polynomial, or other regression technique.

6. The system of claim 1, wherein the processor is configured to determine the state of charge of the test battery while the test battery is disconnected from a power source.

7. The system of claim 1, wherein calculating the nonlinear parameter includes determining a quotient of the amplitude of the second harmonic and the square of the amplitude of the first harmonic.

8. The system of claim 1, wherein the processor is configured to initiate a corrective action based on a comparison of the determined state of charge and a threshold state of charge.

9. The system of claim 1, further including:
an oscilloscope between the ultrasonic receiver and the processor; and
a signal generator between the processor and the ultrasonic transmitter.

10. The system of claim 1, wherein the second harmonic includes a frequency that is twice that of the first harmonic.

11. The system of claim 1, further comprising a temperature sensor communicatively coupled to the processor, wherein the processor is configured to apply a temperature compensation to the nonlinear parameter prior to determining the state of charge of the test battery.

12. A method comprising:
propagate, using an ultrasonic transmitter, an ultrasonic wave through a calibration battery at each of a plurality of states of charge of the calibration battery;
detect, using an ultrasonic receiver opposite of the ultrasonic transmitter, an amplitude of a first harmonic of the ultrasonic wave and an amplitude of a second harmonic of the ultrasonic wave for each of the plurality of states of charge;
for each of the plurality of states of charge, calculate a nonlinear parameter based on the amplitude of the first harmonic and the amplitude of the second harmonic;
calculate a correlation between the nonlinear parameter and each of the plurality of states of charge of the calibration battery and store the correlation in memory;
cause a further ultrasonic wave to propagate through a test battery and detect an amplitude of a first harmonic of the further ultrasonic wave and detect an amplitude of a second harmonic of the further ultrasonic wave;
calculate a nonlinear parameter of the test battery based on the amplitude of the first harmonic of the further ultrasonic wave and the amplitude of the second harmonic of the further ultrasonic wave; and
determine a state of charge of the test battery based on the nonlinear parameter of the test battery and the stored correlation.

13. The method of claim 12, wherein calculating the nonlinear parameter includes determining a quotient of the amplitude of the second harmonic and the square of the amplitude of the first harmonic.

14. The method of claim 12, wherein the second harmonic includes a frequency that is twice that of the first harmonic.

15. The method of claim 12, wherein calculating the correlation is performed in computer logic via linear, polynomial, or other regression technique including machine learning methods.

16. The method of claim 12, wherein the calibration battery is an earlier instance of the test battery.

17. The method of claim 12, wherein the calibration battery and the test battery are of the same type.

18. The method of claim 12, further including initiating a corrective action based on a comparison of the determined state of charge and a threshold state of charge.

19. The method of claim 12, wherein the ultrasonic transmitter and the ultrasonic receiver are each coupled to a processor.

20. The method of claim 19, further comprising:
an oscilloscope between the ultrasonic receiver and the processor; and
a signal generator between the processor and the ultrasonic transmitter.
